(19) United States
(12) Patent Application Publication
(10) Pub. No.: US 2021/0111596 A1
(43) Pub. Date: Apr. 15, 2021

(54) ELECTRICAL MACHINE WITH A SPRING ELEMENT FOR HOLDING A STATOR IN A HOUSING

(71) Applicant: Rolls-Royce Deutschland Ltd & Co KG, Blankenfelde-Mahlow (DE)

(72) Inventors: Frank Latwesen, Oberasbach (DE); Robert Goraj, Erlangen (DE)

(21) Appl. No.: 17/046,769

(22) PCT Filed: Mar. 21, 2019
(86) PCT No.: PCT/EP2019/057019

§ 371 Date: Oct. 9, 2020

(30) Foreign Application Priority Data
Apr. 17, 2018 (DE) 10 2018 205 785.0

(51) Int. Cl. H02K 1/16; H02K 1/18

(52) U.S. Cl. CPC H02K 1/16; H02K 1/185

(57) ABSTRACT

The invention relates to an electrical machine (1) comprising: a housing (2) and a stator (3) which is arranged at least in some regions in the housing (2) and which is held on the housing (2), the electrical machine (1) having an opening (5) which extends in an axial direction (a) of the electrical machine (1), the opening (5) being formed in the housing (2) and in the stator (3), and the electrical machine (1) having a spring element (6), which is arranged within the opening (5) in order to hold the stator (3) on the housing (2).

This application is the National Stage of International Application No. PCT/EP2019/057019, filed Mar. 21, 2019, which claims the benefit of German Patent Application No. DE 10 2018 205 785.0, filed Apr. 17, 2018. The entire contents of these documents are hereby incorporated herein by reference.

### BACKGROUND

The present embodiments relate to an electrical machine including a housing and a stator, and a method for producing an electrical machine of this kind.

In the present case, the interest is in electrical machines that may be used as a drive in a vehicle, for example. Electrical machines of this kind may be used as a drive for an electric airplane. In electrical machines, there is always a joint between the external housing or jacket housing and the stator or laminated stator core. The stator is usually made of a ferromagnetic material (e.g., a “transformer sheet”), and the housing is often manufactured from aluminum or steel.

There is a known practice in the prior art of forming the connection between the stator and the housing by nonpositive engagement. In the case of nonpositive connection, a shrink fit is often used. In the case of an electrical machine, which either has a high torque or a small frictional engagement area, nonpositive connection is often problematic, especially in the case where there are different material pairings between the stator and the housing. At the operating point, the stator and the jacket housing have an approximately equal temperature at the joint, which may be approximately 110° C., for example. Given this temperature rise, the available surface pressure between the stator and housing is often not sufficient to transmit the torque of the electrical machine to the housing owing to unavoidable thermal expansion of the material selected. During the transportation of the electrical machine, the temperature at the joint is equal to the ambient temperature and may fall to as low as −40° C. In this case, the aluminum housing shrinks more than the stator, for example, which causes an increase in the mechanical stress in this component and may lead to fracture of the housing.

There is also a known practice from the prior art of forming the connection between the stator and the housing by positive engagement. In the case of such a positive connection, the laminated core is provided with corresponding projections in the stamping and is secured axially by screwed joints, for example. Positive connection is thus often preferred in the case of electrical machines with a high torque or small joint area, especially in the case where there are different material pairings between the stator and the housing.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a solution as to how a connection between a stator and a housing in an electrical machine may be formed more reliably in a simple manner is provided.

An electrical machine according to an embodiment includes a housing. The electrical machine includes a stator that is arranged at least in some region or regions in the housing. The stator is held on the housing. Further, the electrical machine has an opening that extends in an axial direction of the electrical machine. In this arrangement, the opening is introduced into the housing and into the stator. Further, the electrical machine includes a spring element that is arranged within the opening in order to hold the stator on the housing.

The electrical machine may be used as a drive for a vehicle (e.g., an electrically powered airplane). The electrical machine includes the housing that may also be referred to as a jacket housing. This housing may be manufactured from a metal (e.g., steel or aluminum). The electrical machine includes the stator, which is arranged at least in some region or regions within the housing. This stator may include a laminated core that is formed from a plurality of individual laminations. Further, the stator may have a plurality of teeth with grooves situated in between. Corresponding windings or coils of the electrical machine may be introduced into these grooves. Further, the electrical machine may include a rotor that is arranged concentrically within the stator and is mounted so as to be rotatable relative to the stator.

According to an aspect, the electrical machine has at least one opening that extends along the axial direction of the electrical machine. In this case, this opening is introduced both into the stator and into the housing. In other words, the stator may have a first partial opening, and the housing may have a second partial opening, where the first partial opening and the second partial opening jointly form the opening. This opening may be in the form of a bore. The opening may extend along the entire axial length of the housing and of the stator. The opening may also be in the form of a blind hole. The spring element is introduced at least in some region or regions into the opening. In the correct arrangement of the spring element in the opening, a main direction of extent of the spring element extends along the axial direction of the electrical machine. By virtue of the fact that the opening extends both via the housing and via the stator or laminated core, and that the spring element is introduced into the opening, it is possible to prevent the stator from rotating or moving relative to the housing during the operation of the electrical machine. The electrical machine may include a plurality of openings, into each of which a spring element is introduced. It is thereby possible in a simple and reliable manner to provide that the stator is held on the housing during the operation of the electrical machine.

Positive engagement against rotation of the stator relative to the housing may be brought about by the spring element introduced into the opening. In other words, it is possible, by the positive connection, to prevent rotation of the stator relative to the housing in the circumferential direction of the electrical machine. It is thus possible to compensate mechanically for the torque acting on the stator of the electrical machine, even in the case where there are different material pairings between the stator and the housing. “Different material pairings” refers to materials with different thermal expansion coefficients. This applies especially to the pair in which the stator is manufactured from electrical steel or iron and the housing is manufactured from aluminum or steel.

In one embodiment, the spring element is introduced in an axial direction of the electrical machine into the opening, with an outside diameter being reduced, and the spring element presses against the opening perpendicularly to the axial direction in a correct installation position in the opening. In the uninstalled state, the spring element is relaxed and has a first length. For installation or introduction of the spring element into the opening, the spring element is stretched. The length of the spring element is thus increased. During this process, the outside diameter of the spring element decreases. The spring element is elastically deformed. In the installed state of the spring element in the opening, the spring element presses against the opening or the inside of the opening. After introduction, the spring element contracts with respect to a longitudinal extent. During this process, the outside diameter of the spring element, for example, also increases. It is thereby possible to provide that the spring element is in mechanical contact with the stator and the housing and thus forms the positive engagement for the transmission of the torque from the electrical machine.

In another embodiment, the opening has a round cross section, where a diameter of the opening is smaller than the outside diameter of the spring element in a relaxed state. For example, the opening may have a circular cross section. The spring element may likewise be of round design on an outside, which is associated with the outside diameter. The spring element may be of substantially cylindrical design on an outside of the spring element, for example. It is thus possible to provide the positive engagement in a simple and reliable manner.

The spring element may be configured as a helical tension spring. In other words, the spring element is a helical tension spring. This helical tension spring may be manufactured from a metal (e.g., steel). For example, the spring element is manufactured from a nonmagnetic material. This helical tension spring may be wound from a corresponding spring wire or round wire. The helical tension spring is wound in a helical shape and may be subjected to tensile stress. For example, the outside diameter of the helical tension spring may be constant over a length of the helical tension spring. The spring element or the helical tension spring may be loaded or elastically deformed at both ends by being pulled apart. In this state, the helical spring may then be introduced into the opening and then released. In the opening, the spring element contracts again. During this process, the length decreases, and the outside diameter increases. The respective spring wire or turns of the helical tension spring thus rest in a uniformly distributed manner on the inside of the opening. As a result, the force exerted by the spring is distributed uniformly to the opening or the inside of the opening. For example, it is possible to provide that the spring element rests as completely as possible by the outside of the spring element against the inside of the opening. Reliable positive connection may thus be achieved.

In one embodiment, the electrical machine has, within the opening, at least one recess to receive a portion of a spring wire of the spring element. The recess extends in a radial direction of the electrical machine. The at least one recess or aperture may be present within the opening. This recess may be introduced into the wall of the opening. In this case, the recess may be introduced into the stator and/or the housing. The width or extent of the recess along the axial direction may correspond at least to the diameter of the spring wire. For example, in one embodiment, a plurality of recesses are provided within the opening. The plurality of recesses may be formed in an encircling or helical shape along the opening or the wall of the opening. The plurality of recesses may also be arranged spaced apart and/or parallel to one another.

When the spring element or helical tension spring is introduced into the opening, the individual turns of the spring element may be introduced into the corresponding recesses. For example, in one embodiment, positive engagement against a movement of the stator in the axial direction relative to the housing is brought about by the spring wire portion received in the at least one recess. It is thus possible, by the spring element situated in the opening, to enable the positive engagement with respect to the circumferential direction or direction of rotation, and, by the respective recesses, the positive engagement in the axial direction may be achieved.

In one embodiment, the stator has a laminated core having individual laminations, and, in a region of the at least one recess, at least one of the individual laminations has a shorter length in the radial direction than the remaining individual laminations. In order to provide the recess or aperture in the opening, packaging of the electrical steel sheets or individual laminations may be implemented with different radial heights. In the region of the housing, the recess or that part of the recess that belongs to the housing may be provided by an appropriate milling method. This allows simple production of the at least one recess.

It is further advantageous if the opening is arranged in a region of the electrical machine that is neutral for a magnetic flux. For example, the opening may be arranged in a region of the electrical machine in which the magnetic flux or a magnetic field strength falls below a predetermined limit. In the region in which the opening is introduced into the stator and the housing, the magnetic flux or magnetic field that is produced during the operation of the electrical machine may be neutral. The opening may also be arranged in a region of the electrical machine in which there is no leakage flux, or a leakage flux below a predetermined threshold is obtained. The opening may be arranged above one of the teeth of the stator in the radial direction, for example. The magnetic flux within the stator is thus not affected by the introduction of the opening.

The electrical machine may have a plurality of openings and a plurality of spring elements, where one spring element of the plurality of spring elements is arranged in each of the openings. For example, the openings may be arranged in a manner uniformly distributed in the circumferential direction of the electrical machine. The positive engagement between the stator and the housing may thus be provided in a reliable manner. There is the advantage that a self-centering mechanism for all the spring elements is provided by this solution. This allows simple and reliable assembly of the electrical machine.

A method according to the present embodiments serves to produce an electrical machine. The method includes providing a housing. In addition, the method includes arranging a stator at least in some region or regions in the housing, where the stator is held in the housing. In this method, in one embodiment, the electrical machine has an opening that extends in an axial direction of the electrical machine, where the opening is introduced into the housing and into the stator. Further, a spring element of the electrical machine is arranged within the opening in order to hold the stator on the housing.

Another aspect of the present embodiments relates to a vehicle with an electrical machine according to the present embodiments. In this case, the electrical machine serves to drive the vehicle. The vehicle may be, for example, an aircraft. For example, the vehicle is an electrically powered airplane.

The embodiments presented with reference to the electrical machine, and the advantages thereof, apply correspondingly to the method according to the present embodiments and to the vehicle according to the present embodiments.

Further features of the invention may be found in the claims, the figures, and the description of the figures. The features and combinations of features cited above in the description and the features and combinations of features cited below in the description of the figures and/or shown in the figures alone may be used not only in the respectively indicated combination but also in other combinations, without departing from the scope of the invention.

### BRIEF DESCRIPTION OF THE DRAWINGS

FIG. 1 shows a detail of a stator and a housing of one embodiment of an electrical machine; and

FIG. 2 shows a section through the electrical machine of FIG. 1, in which a spring element is arranged in an opening.

### DETAILED DESCRIPTION

Same or functionally same elements are provided with the same reference symbols in the figures.

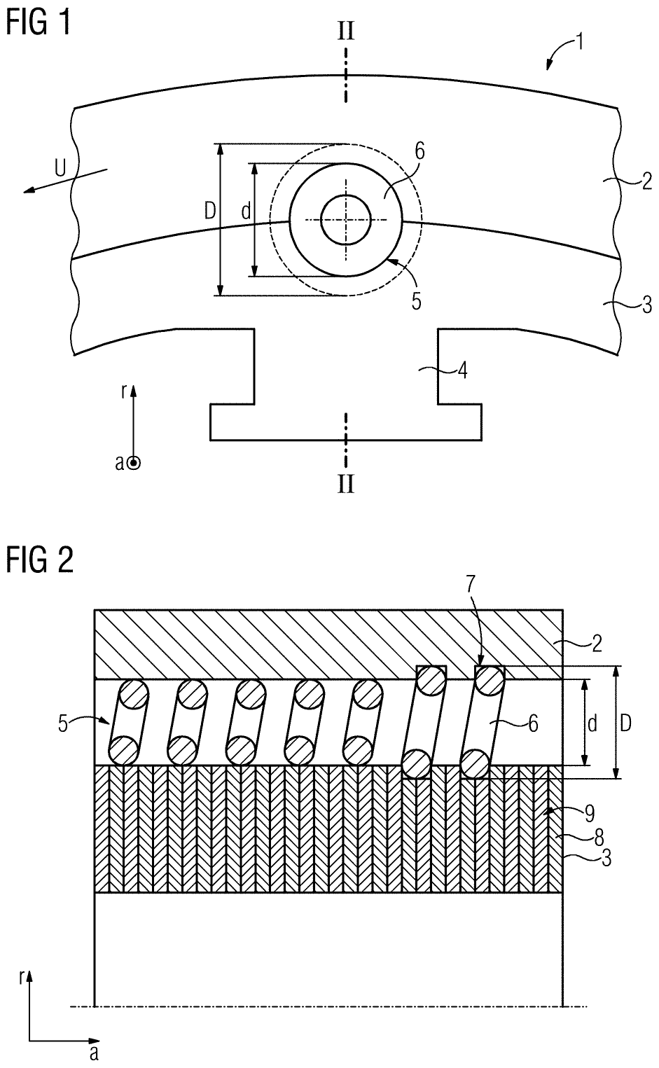

FIG. 1 shows a detail of one embodiment of an electrical machine 1. The electrical machine 1 includes a housing 2 that may be manufactured from a metal (e.g., aluminum or steel). The housing 2 may be of substantially hollow-cylindrical design. Within the housing 2, there is a stator 3 that may be manufactured from an electrical steel sheet. The stator 3 has teeth 4, of which one is shown in the present case.

During the operation of the electrical machine 1, a torque acting on the stator 3 is to be mechanically compensated. For this purpose, the stator 3 may be secured on the housing 2, thus providing that the stator 3 remains in a position or an original installation position or is not moved along a circumferential direction U of the electrical machine 1. For this purpose, the electrical machine 1 has an opening 5 that extends along an axial direction a of the electrical machine 1. In the present case, the opening 5 has a circular cross section. In this arrangement, the opening 5 is introduced both into the housing 2 and into the stator 3. In the example under consideration, the housing 2 has a first partial opening with a semicircular cross section, and the stator 3 has a second partial opening with a semicircular cross section. The first partial opening and the second partial opening jointly form the opening 5. Within the opening 5, there is a spring element 6 that is explained in greater detail below. The opening 5 is situated in a region of the electrical machine 1 or the stator 3 that is neutral with respect to a magnetic flux.

FIG. 2 shows the electrical machine 1 of FIG. 1 along section II-II. FIG. 2 shows that the spring element 6 is configured as a helical spring. In the present case, the spring element 6 is configured as a helical tension spring. The spring element 6 has an outside diameter that is greater than or equal to a second diameter D illustrated in FIG. 2. Further, the spring element 6 has a first length in the uninstalled state. The spring element 6 or tension spring is stretched or pulled in the axial direction a of the electrical machine 1. Pulling increases the length of the spring element 6. As a result of this, the outside diameter of the spring element 6 becomes smaller than a first diameter d of the opening 5. Following this, the spring element 6 is introduced into the opening 5 or slot. After introduction, the spring element 6 contracts. In the installed state, the outside diameter of the spring element 6 is equal to the first diameter d of the opening 5 introduced into the stator 3 and the housing 2. The spring element 6 remains in mechanical contact with the stator 3 and the housing 2 and forms a positive engagement for the transmission of the torque of the electrical machine 1.

A plurality of openings 5, into each of which a spring element 6 is introduced, may be provided along the circumference U of the electrical machine 1. By this solution, a self-centering mechanism for all the tension springs or spring elements 6 is provides. This solution may be used with different material pairings between the stator 3 and the housing 2. “Material pairings” refers to materials with different thermal expansion coefficients. The following pairing may be obtained, for example: The stator 3 may be formed from an electrical steel sheet or iron, and the housing 2 may be formed from aluminum. At the operating temperature of the electrical machine 1, which may be between 110° C. and 120° C., for example, the expansion of the aluminum housing is greater than the expansion of the electrical steel sheet. This expansion is unwanted but unavoidable and, in some circumstances, may result in a radial gap between the stator 3 and the housing 2. As the electrical machine 1 warms up, the spring elements 6 or tension springs contract further and remain in mechanical contact with the stator 3 and the housing 2.

In the exemplary embodiment under consideration, the electrical machine 1 also has recesses 7. These recesses 7 or apertures in the stator 3 and the housing 2 may be achieved by virtue of the fact that individual laminations 8 of the laminated core 9 of the stator 3 have different heights in the radial direction r. In the region of the housing 2, an appropriate milling method may be used to provide the apertures 7. At the locations of the additional recesses 7, the outside diameter of the tension spring or spring element 6 in the installed state corresponds to the second diameter D. The recesses 7 are separated from one another by a plurality of axial offsets. Through the introduction of the wire of the spring element 6 into the recesses 7, the stator 3 is also secured against axial forces by a further positive engagement.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An electrical machine comprising:
a housing;
a stator that is arranged in one or more regions in the housing, the stator being held on the housing,
an opening that extends in an axial direction of the electrical machine, wherein the opening extends into the housing and into the stator; and
a spring element that is arranged within the opening in order to hold the stator on the housing.

2. The electrical machine of claim 1, wherein positive engagement against rotation of the stator relative to the housing is brought about by the spring element introduced into the opening.

3. The electrical machine of claim 1, wherein the spring element is introducible in the axial direction of the electrical machine into the opening, the spring element being stretchable, with an outside diameter being reduced, such that the spring element presses against the opening perpendicularly to the axial direction in a correct installation position in the opening.

4. The electrical machine of claim 3, wherein the opening has a round cross section, and
wherein a diameter of the opening is smaller than the outside diameter of the spring element in a relaxed state.

5. The electrical machine of claim 1, wherein the spring element is configured as a helical tension spring.

6. The electrical machine of claim 5, wherein the electrical machine has, within the opening, at least one recess to receive a portion of a spring wire of the spring element, and
wherein the recess extends in a radial direction of the electrical machine.

7. The electrical machine of claim 6, wherein positive engagement against a movement of the stator in the axial direction relative to the housing is brought about by the spring wire portion received in the at least one recess.

8. The electrical machine of claim 6, wherein the stator has a laminated core having individual laminations, and, in a region of the at least one recess, at least one of the individual laminations has a shorter length in the radial direction than the remaining individual laminations.

9. The electrical machine of claim 1, wherein the opening is arranged in a region of the electrical machine that is neutral for a magnetic flux.

10. The electrical machine of claim 1, wherein the electrical machine has a plurality of openings and a plurality of spring elements, wherein one spring element of the plurality of spring elements is arranged in each opening of the plurality of openings.

11. A method for producing an electrical machine, the method comprising:
providing a housing; and
arranging a stator in one or more regions in the housing, wherein the stator is held in the housing,
wherein the electrical machine has an opening that extends in an axial direction of the electrical machine (1), wherein the opening is introduced into the housing and into the stator, and a spring element of the electrical machine is arranged within the opening in order to hold the stator on the housing.

12. The method of claim 11, wherein the spring element is stretched in the axial direction of the electrical machine and is then introduced into the opening.

13. The electrical machine of claim 2, wherein the spring element is introducible in the axial direction of the electrical machine into the opening, the spring element being stretchable, with an outside diameter being reduced, such that the spring element presses against the opening perpendicularly to the axial direction in a correct installation position in the opening.

14. The electrical machine of claim 13, wherein the opening has a round cross section, and
wherein a diameter of the opening is smaller than the outside diameter of the spring element in a relaxed state.

15. The electrical machine of claim 14, wherein the spring element is configured as a helical tension spring.

16. The electrical machine of claim 15, wherein the electrical machine has, within the opening, at least one recess to receive a portion of a spring wire of the spring element, and
wherein the recess extends in a radial direction of the electrical machine.

17. The electrical of claim 16, wherein positive engagement against a movement of the stator in the axial direction relative to the housing is brought about by the spring wire portion received in the at least one recess.

18. The electrical machine of claim 17, wherein the stator has a laminated core having individual laminations, and, in a region of the at least one recess, at least one of the individual laminations has a shorter length in the radial direction than the remaining individual laminations.
